(19) United States
(12) Patent Application Publication
(10) Pub. No.: US 2001/0034661 A1
(43) Pub. Date: Oct. 25, 2001

(54) Methods and systems for presenting a virtual representation of a real city

(75) Inventor: Jose P. S. Ferreira, New York, NY (US)

Correspondence Address: FISH & NEAVE, 1251 AVENUE OF THE AMERICAS, 50TH FLOOR, NEW YORK, NY, 10020-1105, US

(73) Assignee: VIRTUACITIES, INC.

(21) Appl. No.: 09/783,448

(22) Filed: Feb. 14, 2001

Related U.S. Application Data
(60) Provisional application No. 60/182,282, filed on Feb. 14, 2000.

(51) Int. Cl. G06F 17/60

(52) U.S. Cl. 705/26; 705/27

(57) ABSTRACT

A virtual city service that provides access to a virtual city application is provided. Users may navigate among a virtual representation of a real region, such as a city. The interface may include images of actual city blocks that have interactive items of interest such as storefronts. Users may virtually shop in the stores that adorn the virtual city blocks. The virtual city application may process orders for all merchants—local or web-based. An artificial intelligence component may be used in the form of a back-end linear programming model to provide an intelligent personal assistant. Chore-management may thus be automated.

This application claims the benefit of U.S. Provisional application No. 60/182,282, filed Feb. 14, 2000, which is hereby incorporated by reference in its entirety.

### BACKGROUND OF THE INVENTION

This invention relates to web-based virtual communities, and more particularly to an interactive, navigable, Web-based representation of a city.

Virtual communities are prevalent on the Internet. For example, web pages that provide chat rooms, message forums, and e-mail exist and offer their users the ability to interact with one another. America Online, for example, offers its subscribers access to e-commerce, chat and e-mail features, Internet access, news, and other features.

By offering users a sense of community while online, these services place the users at ease and allow them to be more comfortable while navigating around the virtual communities. However, existing virtual online communities do not give users a sense of realism. That is, although a user may be in a chat channel, perhaps directed towards conversations related to New York City, the chat channel does little to make the user feel like he or she is actually in New York City.

Existing virtual online communities also lack the ability to immerse the user in the virtual community. That is, the user is always aware that he or she is on a Web site and is interacting with data. The user interfaces of existing virtual online communities lack the sophistication that is required to immerse the user in the virtual community.

With the proliferation of the Internet, and the World Wide Web in particular, online shopping has grown in popularity. One of the major benefits of online shopping is the ability to access a wide range of products from a single web page. Because electronic merchants need only maintain stock in warehouses and do not have the additional overhead of maintaining retail stores, they are able to offer more products to online consumers. However, like virtual online communities, online shopping does not offer consumers the realism of real shopping.

Rudimentary one-stop local e-commerce World Wide Web sites, such as Kozmo.com and UrbanFetch.com, are known. For example, Kozmo.com promises to be “Amazon in under an hour.” Kozmo.com warehouses books, compact discs, videos, and some other basic commodities and distributes them around select major cities via courier delivery.

Kozmo.com and UrbanFetch.com (as well as other local e-commerce sites) are fundamentally predicated upon warehouse and distribution. Because the products they sell are so commoditized, there is little need for an interactive consumer experience. The only meaningful role that the Internet plays is that of placing an order for delivery. One could just as easily call in an order. Present local e-commerce sites limit their ability to grow beyond staple items. In order to provide local e-commerce of a majority of the goods and services that one purchases in daily life, a very different approach is required.

Another web-site, HomeDelivery.com, merely provides links to local merchants. However, because individual merchants process payments, a consumer making purchases through HomeDelivery.com must register with and pay each vendor independently, effectively destroying the one-stop shopping model potential.

It is therefore an object of the present invention to provide a virtual community that provides a sense of realism and immerses users in an environment.

It is also an object of the present invention to provide substantially one-stop shopping to users without requiring the users to enter personal information multiple times.

### SUMMARY OF THE INVENTION

These and other objects of the invention are accomplished in accordance with the principles of the present invention by providing a virtual city service that gives it users access to a virtual city application with a comprehensive graphic user interface. The virtual city application may provide one-stop shopping services while not burdening users with repeated requests for personal information.

The present invention is primarily described with respect to an embodiment in which a user interface may be viewed as a World Wide Web site accessible over the Internet. It should be understood that this is merely an illustrative embodiment and that any other suitable arrangement may be used.

In one suitable embodiment of the present invention, a user interface may be provided by the virtual city application of the present invention. The user interface may include a user-navigable virtual representation of an actual location, such as a city. The virtual representation may take the form of digitized images of the actual location that may be spliced together to allow navigation. For example, a user may navigate from one adjacent city block to another by selecting a horizon or any other suitable element of the display, such as icons. The images may be ordinary 2-D images, 180° images, 360° images, 3-D images, or any other suitable types of images. The images may be still images or they may be displayed as video.

Images of city blocks may include virtual storefronts. The virtual storefronts may correspond to actual stores in the real world. In another suitable approach, the storefronts may be computer-generated. Virtual storefronts may be treated as items of interest. Items of interest may generally be selectable. Upon selection, the user may be directed to a web page (in the case of a web-based implementation) that provides more information on the item of interest. For example, upon selection of a storefront, the user may be directed to a virtual representation of the interior of the store in which the user may navigate and view actual items for sale as though he or she were in a real store.

The virtual city application may also provide links (e.g., as an item of interest in an image or as an ordinary hyperlink) to web-based merchants. Whether large web-based merchants or small local merchants, the virtual city application may provide users with the convenience of one-stop shopping. For example, purchases made with merchants that are partnered with the virtual city service may be processed by the virtual city application rather than by the individual merchants. In one suitable approach, the virtual city application may request that the user provide personal and payment information (at registration, for example). This information may subsequently be used for all purchases made through the virtual city application without having the user repeatedly provide the information to numerous merchants. The virtual city application may also provide a single virtual shopping cart, into which users may place items they wish to buy from among any of the merchants that are partnered with the virtual city service. The virtual city service may take a commission for any order that it processes.

The virtual city application may also act as a data gatherer. In one suitable approach, the virtual city application may track the patterns of use by its users. These patterns may relate to shopping, which virtual regions are visited, or to any other suitable criteria. The data may be used by merchants and by the virtual city service for marketing purposes or for any other suitable purpose.

Advertisements may be displayed as embedded advertisements within virtual city images. For example, cars, clothes, signs, banners, billboards, or any other suitable elements may all be selectable in order to provide more information about the manufacturer, product, etc. In one suitable approach, embedded advertisements may be inserted into the virtual city images using graphics processing. That is, the embedded advertisements may exist in the virtual world, but not in the real world.

The virtual city application may also provide chore management utilities. For example, plumbers, doctors, lawyers, dentists, mechanics, or any other service professionals may be searched for and contacted (e.g., for an appointment).

The virtual city application may also provide virtual travel and tourism features. For example, interest-specific virtual tours may be provided whereby users may take virtual tours based on particular preferences (e.g., jazz in New Orleans). The virtual tours may include visits to parades, museums, clubs, restaurants, or any other suitable event or location. The user may navigate among the events or locations using a process similar to that for navigating among virtual city blocks.

The virtual city application may also include an artificial intelligence component. For example, an intelligent personal assistant may be implemented that may provide automated chore-management. Decisions may be made by the intelligent personal assistant based on a linear programming model having a large number of variables. With regard to chore-management, some of these variables may include the user's location, personal preferences, habits, schedule, income, or any other suitable variables. The personal assistant is merely one example of how a linear programming model may be used with the present invention. Any other suitable implementation of a linear programming model may be made.

### BRIEF DESCRIPTION OF THE DRAWINGS

FIG. 1A is a block diagram of an illustrative image-capturing system in accordance with an embodiment of the present invention.

FIG. 1B is a flow chart of illustrative steps involved in making images available to the virtual city application in accordance with an embodiment of the present invention.

FIG. 2 is a block diagram of an illustrative virtual city image distribution system in accordance with an embodiment of the present invention.

FIG. 3 is a block diagram of an illustrative information distribution system in accordance with an embodiment of the present invention.

FIG. 4 shows an illustrative virtual city application display screen for navigating around a virtual city in accordance with an embodiment of the present invention.

FIG. 5 shows the illustrative virtual city application display screen of FIG. 4 in full mode in accordance with an embodiment of the present invention.

FIG. 6 is a flow chart of illustrative steps involved in using a map to navigate around a virtual city in accordance with an embodiment of the present invention.

FIG. 7 is a flow chart of illustrative virtual city application display screens for navigating around a virtual city block image in accordance with an embodiment of the present invention.

FIG. 8 shows an illustrative virtual city application display screen for a store information page in accordance with an embodiment of the present invention.

FIG. 9 is a block diagram of an illustrative arrangement of features that may be offered by the virtual city application in accordance with an embodiment of the present invention.

FIG. 10 shows an illustrative virtual city application display screen for using embedded advertisements in virtual city images in accordance with an embodiment of the present invention.

FIG. 11 is a flow chart of illustrative steps involved in navigating among virtual city blocks in accordance with an embodiment of the present invention.

FIG. 12 shows an illustrative virtual city application display screen for seamlessly integrating the virtual city interface with other web pages in accordance with an embodiment of the present invention.

FIG. 13 is a flow chart of illustrative steps involved in using the virtual city application to process orders in accordance with an embodiment of the present invention.

FIG. 14 is a block diagram of an illustrative arrangement for sharing customer data and marketing information between the virtual city application and merchants in accordance with an embodiment of the present invention.

FIG. 15 is a block diagram of an illustrative arrangement of features that may be offered by the virtual city application in accordance with an embodiment of the present invention.

FIG. 16 shows an illustrative virtual city application display screen for using an avatar in accordance with an embodiment of the present invention.

FIG. 17 is a block diagram of an illustrative relationship between an intelligent personal assistant and a linear programming model in accordance with an embodiment of the present invention.

FIG. 18 is a block diagram of an illustrative arrangement of revenue sources provided by the virtual city application in accordance with an embodiment of the present invention.

### DETAILED DESCRIPTION OF THE PREFERRED EMBODIMENTS

The present invention relates to a localized navigation system that may use digital imagery and sound to recreate, in exacting detail, a virtual reality simulacrum of any desired real world city.

In the preferred embodiments of the present invention, every virtual city may be a digital replica of a real-world city in which users in that community and around the world are allowed to explore, browse, and mingle. Although it may be possible to simulate a real-world city with a virtual city using substantial precision, it may not always be desirable to do so. For example, in order to maintain an environment that is directed towards the general public, offensive material may be filtered out.

In one suitable embodiment, the present invention may be implemented as a World Wide Web site that users may access via, for example, the Internet. As it currently stands, the Internet is a “dumb” finder and sorter of information. The present invention may give the Internet the potential to provide a “smart” sensory experience.

For purposes of brevity and clarity, the present invention is described as a virtual city service made available to the public as a virtual city application via the Internet. It should be understood that this is merely an illustrative embodiment. Any other suitable hardware, software, protocols, networks, or arrangements may be used.

The present invention may provide a new type of Internet service. Both business-to-business and business-to-consumer, customers of the virtual cities service may be varied and many. Large conglomerates and family-owned businesses may both have their place in the virtual city service's online community. Individual users with interests as diverse as traveling, shopping, computer-gaming, and simplifying the business of their daily lives may come to rely on the virtual city service as their first and most-trusted venue on the web. Large vendors may make use of the virtual city service to generate incremental sales and to provide their customers far greater ease of checkout and payment—without losing control of the customer payment information. Small to medium-sized vendors may make use of the virtual cities service to make a presence on the web as part of a large, robust, dynamic community within which they will enjoy economies of scale and access to unique and valuable marketing data.

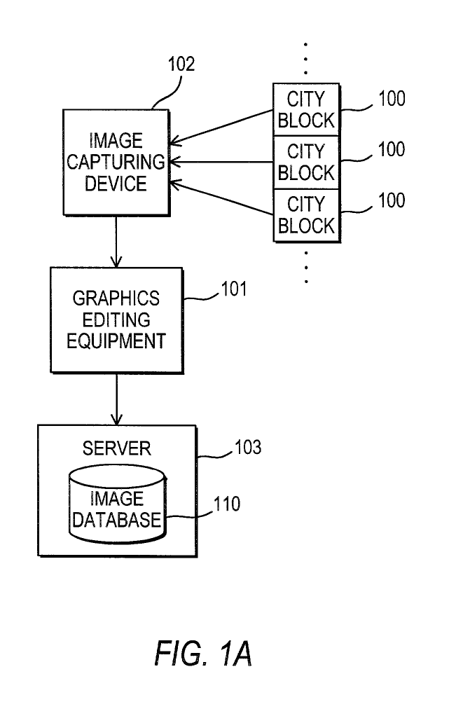

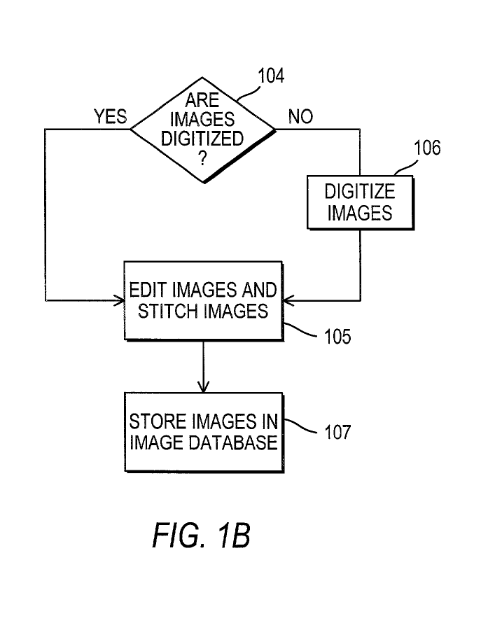

FIG. 1A shows an illustrative system that may be used for procuring images to be used by a virtual city application. The term “image,” as used herein, may refer to either still images, a slide show of still images, video, a slide show of videos, animation, or any other suitable form of imagery. The basic unit of a virtual city may be city block 100. City block 100 may be any suitable fundamental portion of a city. For example, city block 100 may be an intersection, a section of a street, court, or avenue, a section of a road, an area having particular dimensions (e.g., in the shape of a square, rectangle, circle, etc.), or any other suitable fundamental portion of a city. Using any suitable image capturing device 102, such as a 180° digital camera, 360° digital camera, ordinary digital camera, film-based camera, video camera, or any other suitable image capturing device, images of city blocks may be captured.

Some or all of the captured images may be edited, stitched, or manipulated in any other suitable way using, for example, graphics editing equipment 101. Graphics editing equipment 101 may be any suitable equipment, such as personal computing equipment, super-computing equipment, silicon graphics computing equipment, any other suitable equipment, or any combination thereof. The images may be stored in image database 110, which may be located at server 103.

In one suitable embodiment of the present invention, images captured by image capturing device 102 need not be in a digitized format. For example, the images may be hard-copy photographs. At step 104 of FIG. 104, it may be determined whether the images are digitized images. If the images are not digitized, then the images may become digitized at step 106 using, for example, scanning equipment and suitable software. In the case of video, frame capture hardware and software may be used at step 106 assuming a still image embodiment of the virtual city application is being used. If virtual city blocks can be displayed using video, then video clips, streaming video, or any other suitable form of digitized video may be used.

The digitized images may then be edited and stitched together using any suitable stitching technology at step 105 and stored in database 110 at step 107. The stitching may link the images of the city blocks to one another in image database 110. Whatever links exist in the real city, such as from one city block to another, the same links may exist between the digital images of the virtual city. The result may be a network of inter-linking images that may be freely roamed, from one image to another, much like real life. This is merely an illustrative arrangement of hardware and processes. Any other suitable arrangement and processes may be used.

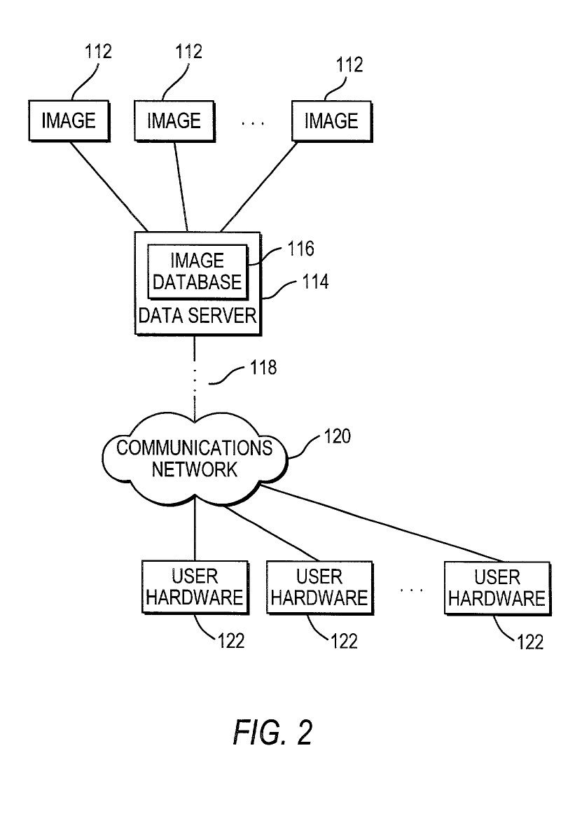

FIG. 2 shows an illustrative system for the present invention. Image data 112 may be loaded into data server 114 that holds image database 116. Image database 116 may be accessed by user hardware 122 using communications network 120. Communications network 120 may be the Internet, a modem connection, a wireless communications path (e.g., using wireless access protocol (WAP)), a satellite connection, a television cable connection or any other suitable peer-to-peer based or client-server based communications network. Data server 114 is shown to be coupled to communications network 120 using path 118. Path 118 may include intervening hardware, such as one or more web servers, data servers, proxy servers, gateway servers or any other suitable intervening hardware. If desired, these or any other suitable servers may be combined so that less hardware is used. For example, data server 114 may be combined with a web server. Any such suitable combination may be used if desired.

It should be understood that although only image data 112 is shown in FIG. 2, any other type of data may be acquired and stored in a database for use by the virtual cities application. For example, audio data, text data, advertisement data, navigation data, or any other suitable data may be stored in data server 114 or in any other suitable server. Any or all types of data may be stored in a single data server. If desired, multiple data servers may be used to store data. Data servers may be separate servers dedicated to holding one or more databases, or alternatively, data servers may be combined with other types of servers, such as web servers, proxy servers, or any other suitable type of server.

User hardware 122 may be any suitable user hardware, software, or both. For example, user hardware 122 may be a personal computer with web-browsing software that may be used by users of the virtual city application to navigate among a virtual city via communications network 120. Alternatively, user hardware 122 may be a personal computer with image-capturing hardware and suitable image-processing software that is located at a local retail site (e.g., a grocery store). In this case, user hardware 122 may provide data server 114 with updated images of the local retail site via communications network 120. In another suitable approach, updated images of the local retail site may be made available to data server 114 using any other suitable arrangement.

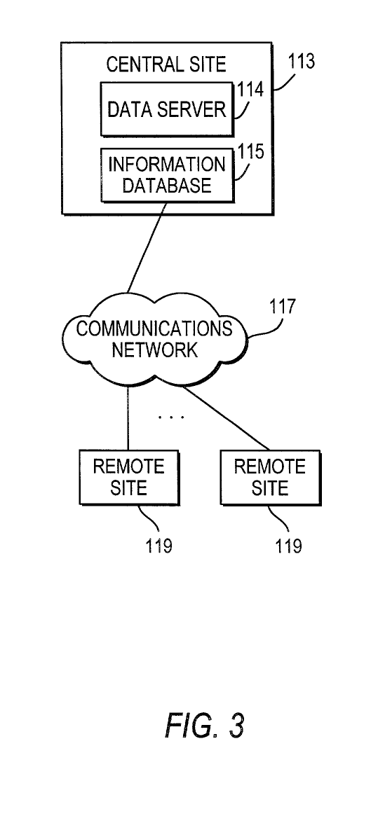

FIG. 3 shows an illustrative back-end system that may be used for the present invention. A central site 113 may be used to hold data server 114 and information database 115. Central site 113 may be in one physical location, or, alternatively, central site 113 may include components that are located at more than one location.

Information database 115 may be stored in data server 114, or, alternatively, information database 115 may be stored on a separate server. If desired, information database 115 may be partially stored in data server and partially stored on one or more other servers. Information database 115 may be used to store user information such as names, addresses, telephone numbers, and any other suitable user information. In one suitable approach, user information may include any suitable payment information such as credit card information, bank account information, or any other suitable payment information. In yet another suitable approach, user information may include behavioral data. Behavioral data may be acquired for each user based on the user's usage patterns in the virtual city application, such as which local merchants the user often visits using the virtual city application or any other such suitable usage patterns.

Remote sites 119 may access information database 115 using communications network 117. Communications network 117 may be the same as communications network 120, or communications network 117 may otherwise be any such suitable communications network. Remote sites 119 may include local merchants, web-based merchants, credit processing stations, marketing consultants, or any other suitable remote sites.

One of the features of the present invention is the interface of the virtual city application. In a real world city, any given block might contain many items of interest, such as storefronts, monuments, parks, statues, famous buildings, or any other suitable items of interest. The virtual city image of that block may contain one or more links (e.g., hyperlinks), each associated with the corresponding real world item of interest. In a web-based approach, hyperlinks may be embedded within the image of the city block. If desired, the hyperlinks may be made available to the user outside of the image of the city block, such as in a separate listing of hyperlinks associated with the currently displayed city block. This separate listing may be displayed in a separate section on the user display screen. In another suitable approach both a separate listing of hyperlinks and embedded hyperlinks may be used. When the user selects a hyperlink, additional information regarding the item of interest associated with the selected hyperlink may be displayed to the user.

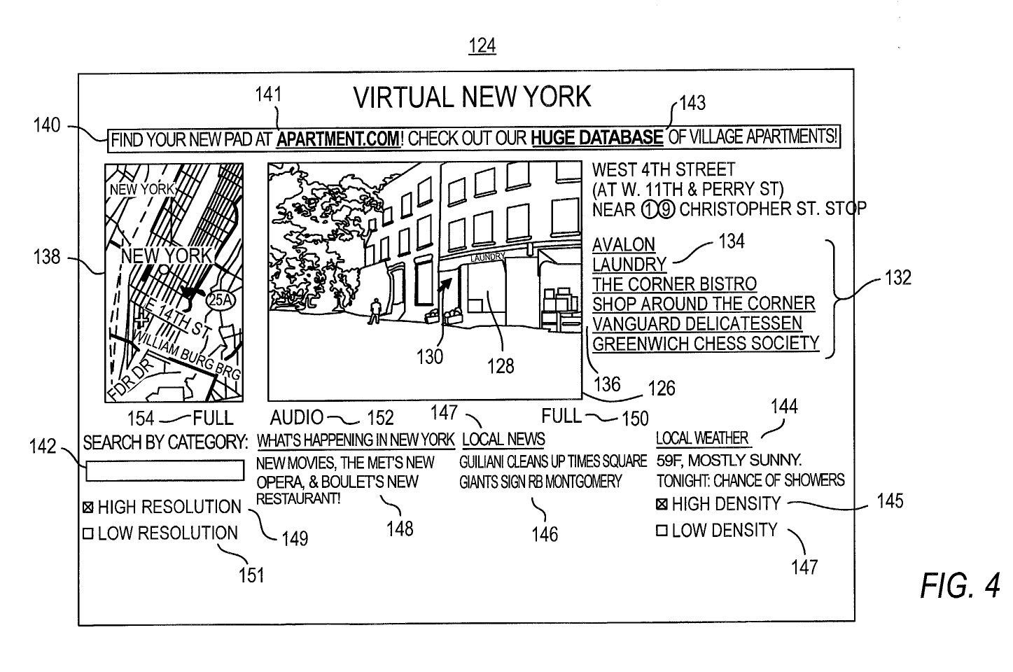

FIG. 4 shows an illustrative virtual city application display screen 124. City block image 126 may be displayed to the user. City block image 126 may include storefronts such as storefront 128. The user may position a cursor 130 over storefront 128 and may select storefront 130 as a hyperlink. In addition, hyperlink listings 132 may be displayed on virtual city application display screen 124, allowing the user to select an item of interest from a textual based list rather than directly from the image. For example, listing 134 corresponds to storefront 128. Either the embedded hyperlink or the text-based listing may be selected by the user to display additional information about that particular item of interest.

The hyperlink listing feature is particularly useful when the item of interest in not visible or is poorly visible in the city block image. For example, city block image 126 corresponds to a New York City block on which the “Vanguard Delicatessen” is found. However, the Vanguard Delicatessen storefront is not viewable in city block image 126. The user may retrieve more information about the Vanguard Delicatessen via its corresponding hyperlink listing 136.

If desired, hyperlink listings 132 may also include hyperlinks to items of interest that are related to items of interest found in the corresponding city block. For example, if a car dealership is a particular item of interest on a particular city block, then a possible additional hyperlink listing may be a hyperlink to a car mechanic in the immediate area. Any such suitable use of hyperlink listing 132 may be used.

A map such as map 138 may be displayed on virtual city display screen 124. Map 138 may show the user the location of the presently displayed city block 126. If desired, map 138 may also show neighboring attractions, such as parks, monuments, etc. Hotels, theaters, and nearby restaurants may also be displayed on map 138. This is merely an illustrative use of maps in the virtual city application. Any other suitable arrangement may be used.

Advertisements, such as advertisement 140, may be displayed on virtual city display screen 124. Advertisement 140 may be a banner advertisement, or if desired, advertisement 140 may be displayed in the form of panel advertisements. Advertisement 140 may contain text, graphics, video (including animation), or a combination of these or other suitable types of content. Advertisements may be interactive. For example, advertisement 140 has interactive regions 141 and 143. If the user selects interactive region 141 (e.g., using cursor 130), a web page corresponding to Apartment.com may be opened and displayed. Likewise, if interactive region 143 is selected, a web page corresponding to an apartment database at Apartment.com may be opened and displayed. Advertisements need not contain multiple interactive regions, but may simply be selectable. If desired, passive advertisements may be used. Any suitable advertisements may be used in conjunction with the virtual city application. Advertisement 140 is merely an illustration.

Updated information such as news, local events, weather, reviews, etc. may be displayed on virtual city application display screen 124. For example, city events and information 148 may be displayed. Local news 146 may be displayed. Local weather 144 may be displayed. The updated information may correspond to the city in which the presently displayed city block is. If desired, updated information regarding the neighborhood in which the presently displayed city block is may be displayed. If desired, updated information regarding the block itself may be displayed. The information displayed on virtual city application display screen 124 may include snippets of information that may be made available to the user upon request. For example, local news 146 may include short headlines to make the user aware of the top local news stories. For additional, more in-depth coverage of the local news, the user may select a hyperlink associated with local news 146 (e.g., a particular headline may be selected, or local news title 147 may be selected, etc.). Once selected, a new web page may be displayed having additional information. This is an illustrative arrangement of displaying local information on a virtual city application display screen. Any other type of suitable arrangement may be used.

In one suitable embodiment, the virtual city application may offer the user an opportunity to search for items of interest. For example, one or more keywords may be entered by the user in search box 142. The search may be limited to searches by category (as illustrated), or the searches may be limited to other parameters. In another suitable approach, no limitations need be placed on searches.

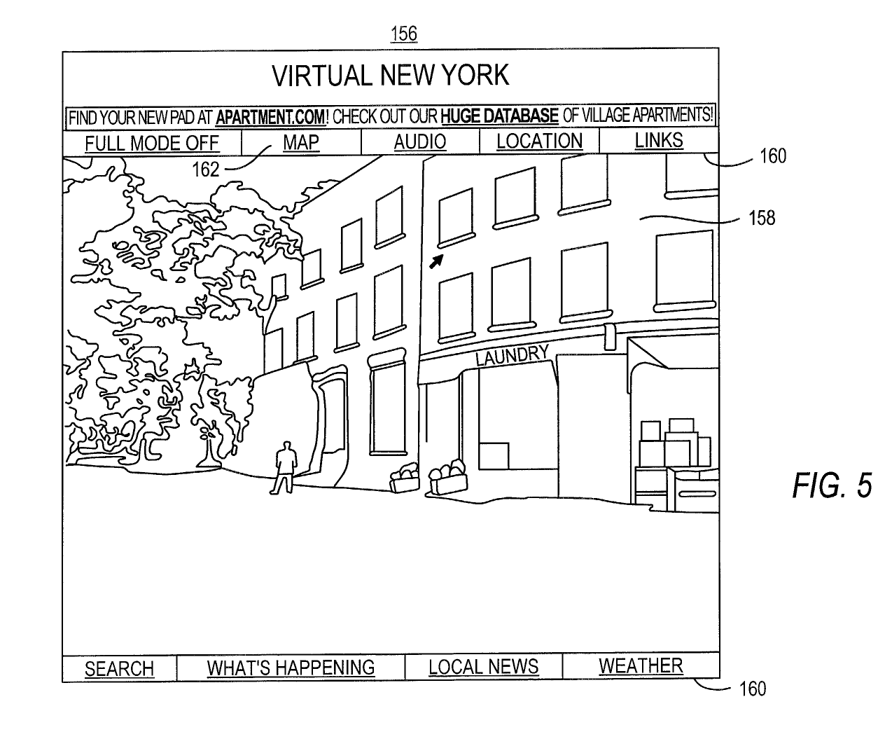

Various items on the virtual city application display screen may be shown in more than one mode. For example, city block image 126 may be shown in either full screen mode or in regular screen-size mode. The default mode may be the regular mode. Screen 124 shows city block image 126 in regular mode. A full option 150 may be provided that may allow the user to enlarge city block image 126 so that it fills the entire browser window or the computer screen. In full mode, every other item of functionality may become a button at the top or bottom of the display screen (or browser window, if the browser window is not maximized). This is illustrated in FIG. 5. City block image 158 is the full mode version of city block image 126 (FIG. 4). Buttons 160 may correspond to the various items of functionality displayed in screen 124 of FIG. 4. For example, map button 162 in screen 156 may correspond to map image 138 in screen 124. To retrieve the image of the map, the user may select map button 162. This may cause a full mode map image to appear. In one suitable approach, selecting map button 162 may cause the display screen to be changed to regular mode, thus displaying the map image in regular mode. If desired, selecting map button 162 may cause a new web page to be displayed that includes a map image. The new web page may be displayed in place of the currently displayed web page in the current browser window, or the new web page may be displayed in a new browser window overlaying the current browser window.

In one suitable embodiment, resolution options 149 and 151 may be provided to the user. Because the connection speed of different users may stretch across a large range, the user may be given the opportunity to choose a resolution level of the virtual city block images that best corresponds to the connection speed being used by the user. The resolution level may include the level of image quality, image size, colors used, or any other suitable components.

Density options 145 and 147 may be provided to the user. The user may be given the opportunity to choose a density level of items of interest and virtual city blocks to be displayed. The density level may correspond to whether certain virtual city blocks should be displayed based on the number of items of interest that are present on the blocks. For example, if the user is using a slow modem connection, then he or she would not wish to download images of virtual city blocks that are empty alleys. By setting the density to a lower level, these virtual city blocks may be skipped as the user navigates through the virtual city.

Density options 145 and 147 and resolution options 149 and 151 are merely illustrative. If desired, more choices of resolution levels and density levels may be provided (e.g., a quantitative resolution level may be used). If desired, the resolution level and density level may be automatically assigned by the virtual city application that may take into account the user's connection speed and personal preferences. The user may still, however, retain the ability to alter these automatic settings.

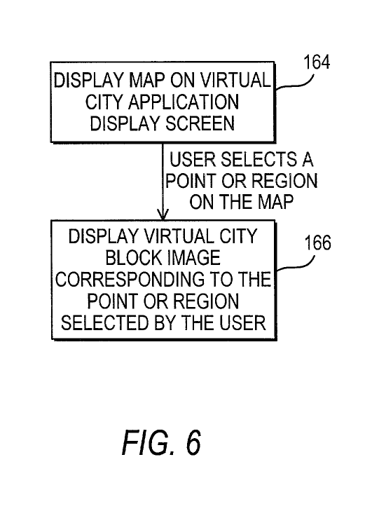

One of the navigation utilities that the virtual city application may provide to the user is the ability to select a point or a region in map 138 to view the corresponding virtual city block image for the selected point or region. This process is illustrated in FIG. 6. At step 164 a map is displayed on the virtual city application display screen. The user may choose a point or region on the map, using, for example, a cursor controlled by a mouse. In response, at step 166, the virtual city application may display a virtual city block image that may correspond to the point or region selected by the user.

The full mode option may also be provided for map 138 to provide greater detail. This is helpful, for example, in order to view the map in block-by-block detail. Furthermore, this feature may provide greater ease of navigation. Whereas selecting an area on the regular mode map may direct the user to the general area selected on the map, clicking on the full mode map may direct the user to the exact block the user desires. This is merely an illustrative use of the map feature of the present invention. Any other suitable use may be implemented for the map feature.

Audio option 152 may also be provided. Audio option 152 may allow the user to listen to location-specific ambient sound. Each virtual city block may be associated with a code (e.g., stored in a relational database) that corresponds to an audio track. These audio tracks may include sounds typically heard on highways, busy streets, residential streets, intersections, parks, etc. The user may activate the audio feature by selecting audio option 152. Likewise, the user may be given the ability to deactivate the audio feature by selecting an appropriate item on the virtual city application display screen. Any such suitable use of an audio feature may be used. If desired, other, more interactive sounds may be provided (e.g., a microphone may be installed on all or particular city blocks, and the user may be given the opportunity to listen to the sounds in real-time). Alternatively, the sounds of a particular block may be recorded as audio clips available to the user at a later time.

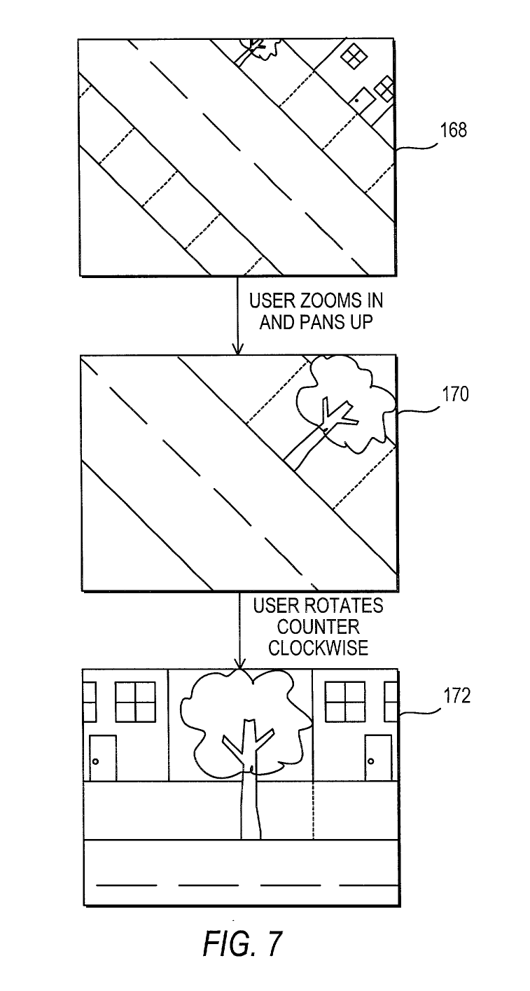

Virtual city block image 126 (as well as the counterpart full mode virtual city block image 158) need not be static. The virtual city application may provide the user with the ability to navigate within the virtual city block image. For example, the user may be given the ability to use a mouse (or the cursor keys on a keyboard) to move within the virtual city block image. This feature is particularly useful when the virtual city block image is a 180° image or a 360° image because the user may be given the ability to navigate the city block to a higher degree using the virtual city block image. The navigation may be accomplished by clicking on the virtual city block image and holding down either the left or right mouse button. This may alter the perspective and create the appearance of movement. Navigation functionality may include pan left, pan right, pan up, pan down, zoom in, zoom out, rotate, any combination thereof, or any other suitable function. FIG. 7 illustrates the use of some of these navigation functions. Virtual city block image 168 may be a 360° image of a particular real city block. If the user zooms in and pans up, virtual city block image 170 may be displayed. If the user then issues a command associated with counterclockwise rotation, virtual city block image 172 may be displayed. The navigation may take place in a smooth and continuous manner, giving the user the impression of actual movement. That is, the user may feel that he or she is actually moving his or her head to get a different view of the city block.

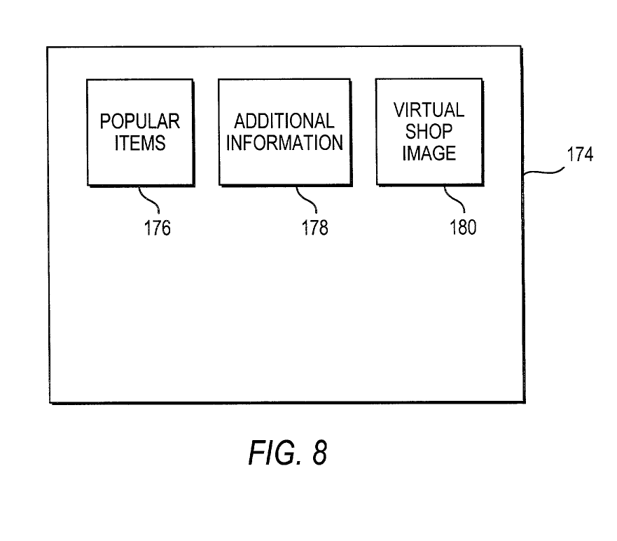

In one suitable embodiment, selecting a storefront such as storefront 128 may link the user to a web page containing a detailed image of that establishment, with information on its location, phone number(s), nearest subway stop, and the goods sold there. If desired, any other suitable information may be provided. An illustrative information web page 174 is shown in FIG. 8. A list 176 of the most popular items or categories of items sold at the selected store may be displayed to the user. Any other suitable number of most popular items may be displayed. If desired, other criteria may be used for displaying items. For example, items may be displayed based on the merchant's choice based on, for example, current sale items. Any such suitable criteria may be used to determine which items to display. This feature may allow the user to have an accurate sense of whether the shop carries the particular item for which he or she is looking. Other information 178 about the store may be provided, such as its history or a brief biography of the proprietors. In one suitable approach, the navigable virtual image feature as hereinbefore described for virtual city block images may be used for the interiors of stores and other establishments selected by the user. Virtual shop image 180 may therefore be displayed on web page 174. The user may be given the ability to navigate around the virtual store image (e.g., using panning, zooming, and rotating features) using, for example, either regular mode or full mode. In one suitable approach, users may navigate around a virtual store using any suitable features, including, but not limited to, those shown in FIGS. 4 and 5. The preceding is merely an illustrative embodiment of a store information web page. Any other suitable design, arrangement, information, and features may be used.

Every storefront in every virtual city block image may be selectable by the user. In another suitable approach, some storefronts may merely be passive images. Upon selection of a storefront, a web page such as web page 174 may be displayed to provide further information about the selected storefront. In another suitable approach, any other suitable web page may be displayed in response to a selection of a storefront.

This is merely an illustrative use of information web pages. Similar detail may be made available for any or all items of interest—not just storefronts. Every park and monument, every restaurant and theater, every church and community center, may have corresponding information on its history, hours of operation, show-times, reviews, and goods and services provided, or any other suitable information made available via the virtual city application.

In one suitable embodiment of the virtual city service of the present invention, information web pages such as web page 174 may be provided to merchants (i.e., merchants of the storefronts in the virtual city blocks) without cost. This will allow for a greater number of stores to be represented in the virtual city.

In another suitable approach, web-based e-commerce merchants may have a presence in the virtual city community as well. For example, virtual storefronts may be created in place of, for example, empty lots. These virtual storefronts may be used by, for example, e-commerce merchants that do not have any physical establishments in the real city. In another approach, real stores may change their locations or add new locations by creating virtual storefronts in any suitable location in the virtual city.

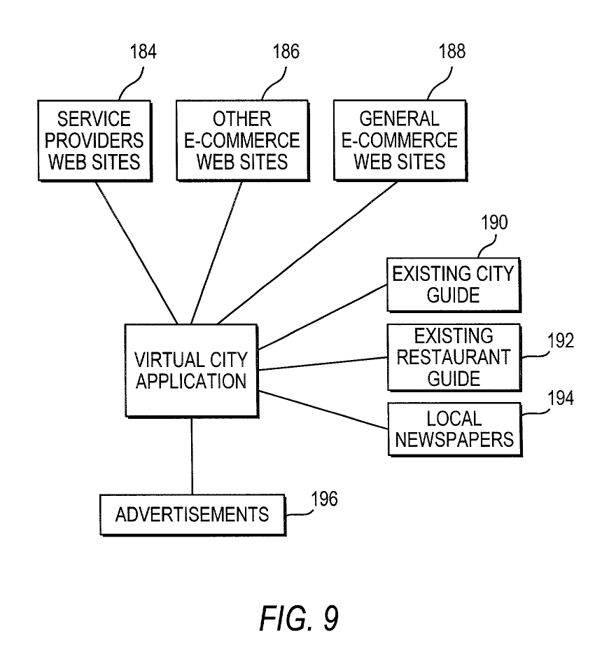

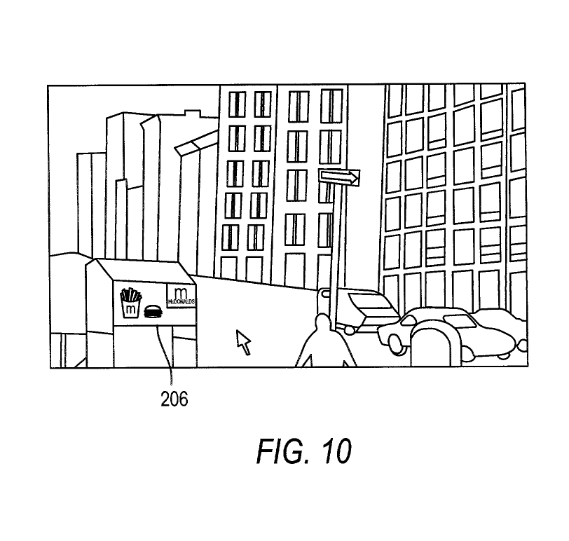

In one suitable embodiment of the present invention, the virtual city application may be used to display advertisements to users. FIG. 9 shows advertisements 196 being used in the virtual city application. Advertisements 196 may include banners, icons, text, video, images, embedded advertisements, and any other form of advertisements. Embedded advertisements are advertisements that are part of the virtual city block images. For example, FIG. 10 shows a typical view of a virtual city block image. Sign 206 is an advertisement for McDonald's. The virtual city application may allow the user to select sign 206 as an embedded advertisement. Upon selection, the user may be directed to a web page giving more information about the advertised product or service. This feature may be applied to billboards, posters, signs, murals, clothing, automobiles, and essentially anything visible in the virtual city image.

If an advertiser, retailer, manufacturer, or merchant does not wish to have real advertisements and items that are visible in the virtual city block image to be embedded advertisements, those items may be made to be passive. Alternatively, those items may be substituted with other items for which another advertiser, retailer, manufacturer, or merchant does want an embedded advertisement. This may be done using any suitable computer graphics software to edit the virtual city block image.

In one suitable approach, embedded advertisements may be used by local merchants to the extent that real world advertisements can not. For example, a local grocery store may advertise itself using, for example, an embedded advertisement such as a billboard that may be added to a virtual city block image using any suitable graphics processing hardware, software, or both. This billboard may be viewed by residents of the neighborhood, visitors of the neighborhood, or by any other users of the virtual city application by navigating to the virtual city block. In this respect, smaller, local merchants may reach the large audiences a billboard is intended to reach, but without going through the process (e.g., acquiring permits, payment of large fees, etc.) of physically placing a billboard up. This is merely an illustrative approach to local advertising. Any other suitable approaches may be used.

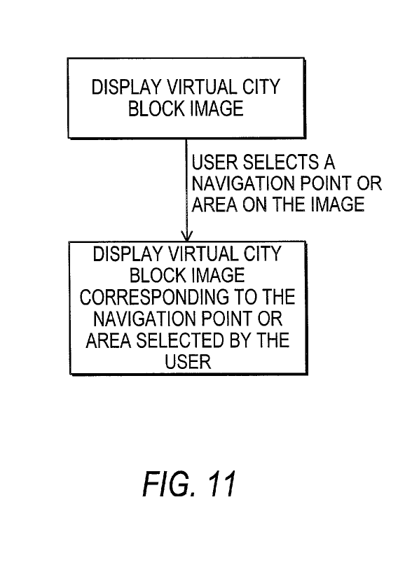

In one embodiment of the present invention, the virtual city application may allow users to navigate around the virtual city by providing selectable horizons. That is, the user may select the end of the currently displayed city block represented by the virtual city block image (e.g., the end of the street). This may cause a virtual city block image corresponding to the block adjacent to the currently displayed virtual city block to be displayed. The direction may be determined by the area the user selected. For example, if the user selects the end of the block, the next block after the point selected may be displayed. If the user selects the other end of the block, then the block adjacent to that end may be displayed. Likewise, if the user selects a side of the displayed block, the block adjacent to the selected side may be displayed. This method of navigation is illustrated in FIG. 11.

In addition to user interface features, the virtual city application of the present invention may offer its users many types of on-line resources using the interactive nature of its interface. Some of these resources, as illustrated by FIG. 9, may include, but are not limited to, links to general e-commerce web sites 188 (e.g., Amazon.com, Buy.com, etc.), links to other local e-commerce sites 186 (e.g., UrbanFetch.com., Kozmo.com, etc.), links to service providers 184 (e.g., on-line banking, etc.), links to existing on-line city guides 190 (e.g., sidewalk.com, etc.), links to existing on-line restaurant guides 192 (e.g., Zagats.com, etc.), links to existing on-line local newspapers 194 (e.g., nypost.com, etc.), links to existing on-line national newspapers (e.g., msnbc.com, etc.), as well as links to any other suitable on-line resources. Agreements between the provider or providers of the virtual city application and the providers of the on-line resources being linked from within the virtual city application may be made.

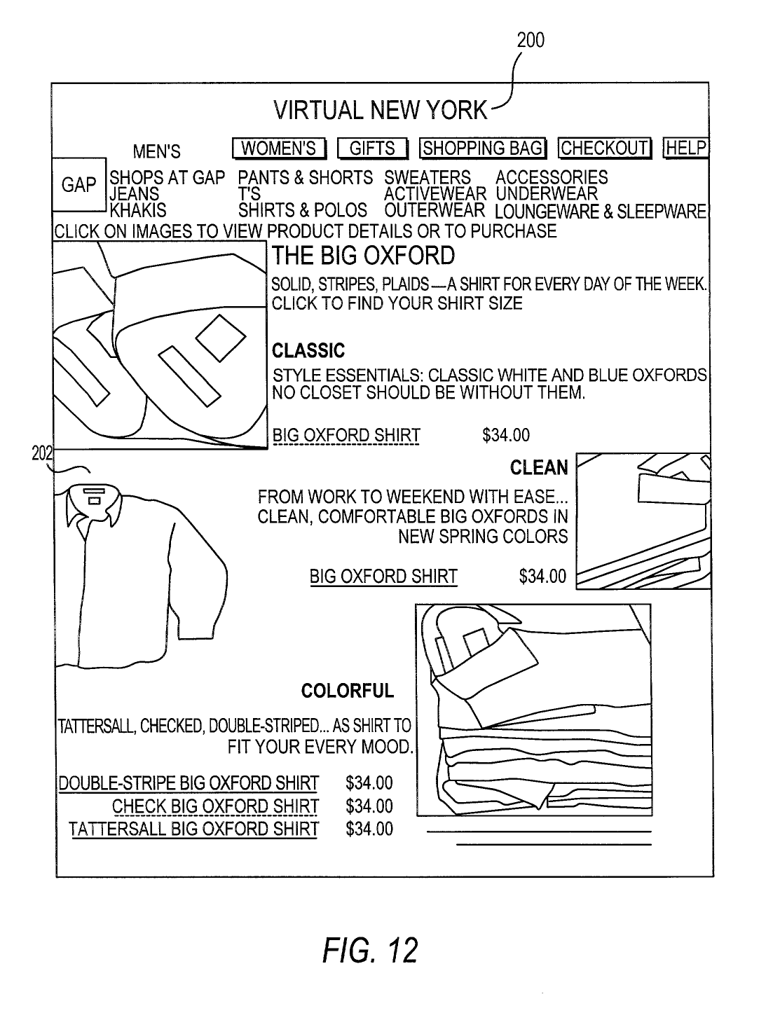

If desired, certain modifications may be made to the on-line resource web page so that the user may be directed to the on-line resource web page from the virtual city application seamlessly. For example, these modifications may include having the color scheme of the on-line resource match the color scheme of the virtual city application interface. If desired, these modifications may include displaying the on-line resource web page in a frame within the virtual city application interface. If desired, an interface such as that illustrated in FIG. 12 may be used, whereby the on-line resource web page may be displayed in combination with virtual city application content without the use of frames. This method of seamless integration of content provides a co-domain environment in one web page. Heading 200 may be displayed and may correspond to the provider of the virtual city application. Heading 200 may be selectable. If the user selects header 200, the user may be redirected to the virtual city web page.

While navigating in an e-commerce web site, or any other type of web site, the user may always return to the main virtual city application web site. For example, after making a purchase using the virtual city application to process the order, the user may be returned to the virtual city application web site. Even if the user does not purchase anything, the user may always be given the ability to return to the virtual city application web site. For example, in FIG. 12, the user may simply click on heading 200 (which may be displayed on every web page of the web site, no matter how deeply into that web site the user travels) and be returned to the virtual city application web site. Any other suitable method, interface design, or both may be used for always giving the user the ability to return to the virtual city application web site.

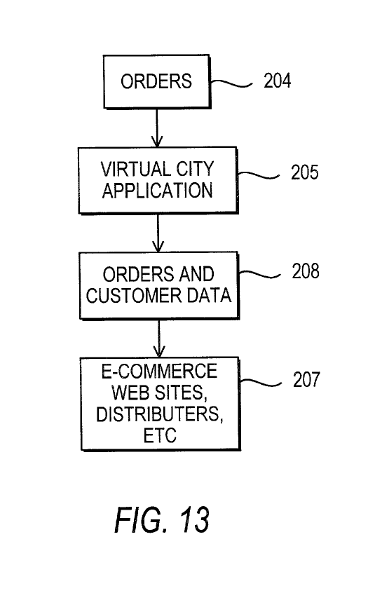

In the case of e-commerce web sites, such as the one shown in FIG. 12, if the user desires to make a purchase, and selects the appropriate icon, link, banner, button, etc., the user may process his or her purchase order through the virtual city application and the virtual city service. For example, if the user wishes to purchase an item from Gap.com, the user may progress through the Gap.com web page (that may have been seamlessly integrated with the virtual city application and the user may view the content normally displayed on Gap.com, including product descriptions, item descriptions and images, etc. When the user wishes to make a purchase, however, the order may be processed through the virtual city application rather than through Gap.com's own servers. Payment may be made to the virtual city service rather than to Gap.com. This process is illustrated in FIG. 13, which show customer orders 204 being processed by virtual city application 205, that in turn sends orders and stored customer data 208 to appropriate merchants 207 for fulfillment. Orders 204 may include any suitable information about customer orders, such as item descriptions, item identification numbers or codes, quantity information, color and size information, or any other suitable customer order information. Order and customer data 208 may include the customer order information of order 204 as well as any suitable customer data that is stored by the virtual cities application.

By linking all order processes from all e-commerce web sites accessible through the virtual city application, the user is given the ability to shop for items at multiple places, each purchase being made through a single source. This allows the user to register only once. The subjection of the user to queries for personal and payment information is therefore minimized using the virtual city application. Instead of having to register and provide payment information at every web site at which the user wishes to make a purchase, the user may simply have all purchases made through the virtual city service using the virtual city application. In one suitable approach, the user may also be given the ability to go from web site to web site, adding items to a virtual shopping cart. After all desired items are in the virtual shopping cart, the user may process the order using the virtual city application.

The one-stop method of e-commerce shopping as described is merely illustrative. Any other suitable method may be used. For example, the virtual city application need not process any orders. If desired, the virtual city application may only process orders for certain merchants, perhaps based on whether the merchant desires to take advantage of the feature.

FIG. 13 also shows customer data being transferred from the virtual city application to the e-commerce site. Customer data may include information such as information that the user entered when the user registered for the virtual city service. This may include such information as name, addresses, telephone numbers, e-mail addresses, survey answers, as well as any other suitable information. The e-merchant may be provided with the information without the user having to enter the information again. The information may be used for any suitable purpose. For example, the information may be used for marketing purposes, for building a customer database, for delivery information, or for any other suitable purpose.

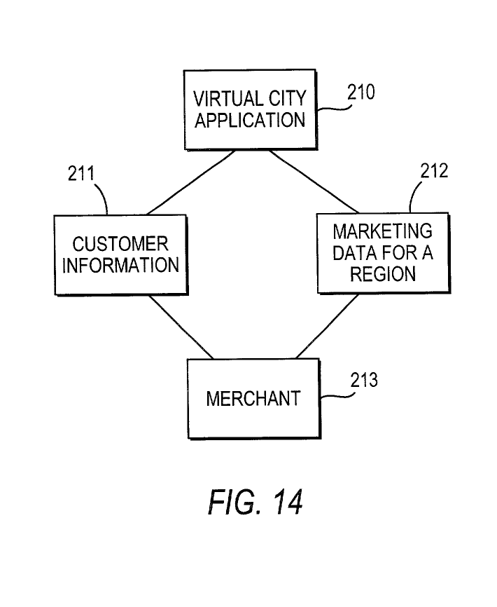

The virtual city application may also provide merchants (including large e-commerce merchants as well as local shops) with marketing data for particular regions. The virtual city application may compile marketing data based on the sales it processes. In an alternative approach, marketing data may be based on any other suitable interactions between users and the virtual city application. This data may be provided to merchants in order to, for example, better serve the merchants' marketing efforts in terms of, for example, advertising. FIG. 14 shows merchants receiving individual customer information as well as general marketing data for one or more regions of a city. Virtual city application 210 may provide customer information 211 and marketing data 212 to merchant 213. The precision of the marketing data is high given the fact that the virtual city application is collecting a vast amount of data by acting as the middleman in e-commerce transactions that spread across a wide spectrum of merchants.

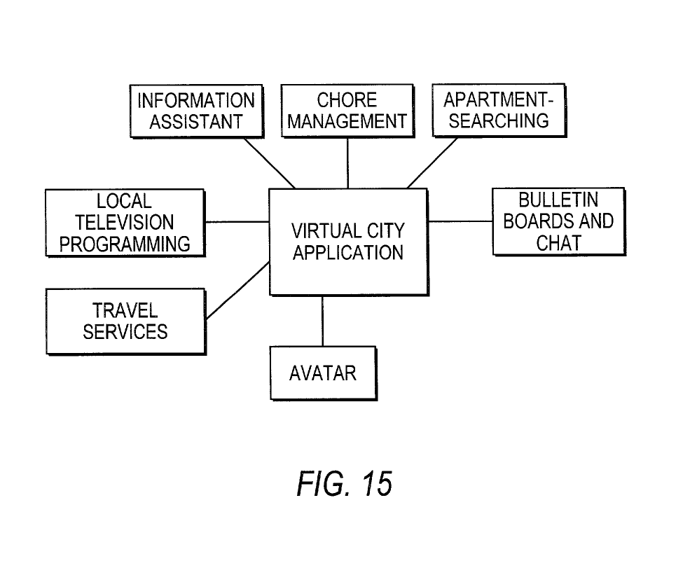

The virtual city application may be made to be as robust as desired. FIG. 15 illustrates some other features that the virtual city application may offers its users. These features may include chore management services, apartment searching services, bulletin board messaging and chat services, an avatar feature, travel services, local television programming, and an intelligent information assistant. The next several paragraphs will describe these features in more detail. It should be understood that any such suitable features may be implemented and that these features, herein described, are merely illustrative.

Chore management services may allow the user to access services (i.e., as compared to products) using the virtual city application. These services may include, but are certainly not limited to, allowing the user to pay bills online, schedule appointments (e.g., for doctors, lawyers, job interviews, plumbers, etc.), make restaurant reservations, do on-line banking, balance a checkbook, as well as any other suitable services, including giving the user the ability to find and try new service providers. As with product purchases, service purchases may be made using the virtual city application as the payment processor in accordance with the present invention.

The virtual city application may also provide apartment searching services. For example, real estate brokers and agents may have listings of available apartments (and houses) available through the virtual city application. The user may select these listing to be given a virtual tour of the apartment. The virtual tour may be given in a manner similar to allowing the user to navigate among virtual city blocks as described hereinbefore. That is, the user may be given the ability to navigate around the apartments using, for example, 360° images of the apartment. The user may be given the ability to open doors, look in closets, look out the window, and hear the sounds in the apartment (e.g., to find out how noisy it is). If desired, a virtual real estate agent may speak as the user tours the apartment. The pre-recorded speech may correspond to what the user is currently viewing. The user may be given the ability to navigate around the neighborhood by simply using the virtual cities application to view the virtual city blocks as hereinbefore described. This is merely an illustrative description of the apartment searching feature. It should be understood that any other suitable method of using the present invention for apartment searching may be used. For example, private owners may be given the ability to place links in a classifieds section of the virtual city application advertising their apartment for rent. It should also be understood that this feature may be expanded to include apartment sales, house sales, land sales, commercial building leasing and sales, etc.

Because the virtual city application is intended to represent a real community, bulletin board messaging and chat functionality may be added. Users may post messages or chat about certain topics or may post messages and chat to each other based on where in the virtual city they currently are. For example, users viewing the virtual South Street Seaport in Manhattan may be given the ability to chat to other users currently viewing the South Street Seaport as well.

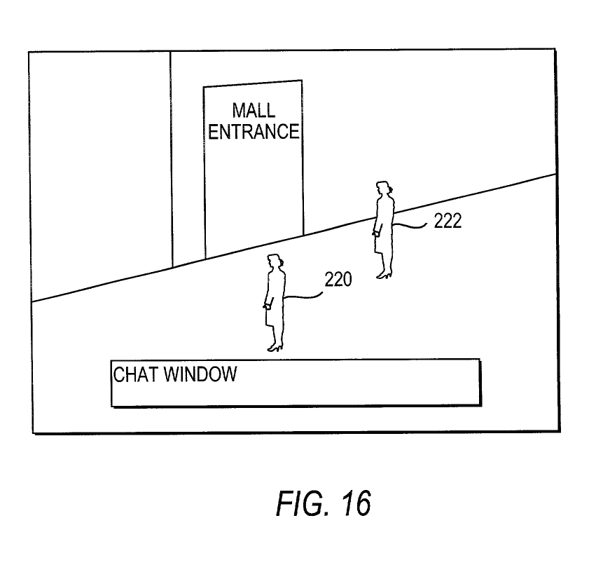

Avatars may also be provided by the virtual city application. Avatars may be graphical representations of online identities. That is, an image of a person or any other suitable entity may represent a real person navigating around virtual city. These images may be actual images of the users using the virtual city application, they may be arbitrary images, or they may be any images chosen by the users. Avatars may allow people from distant places to meet at a particular place in the virtual city environment and, for example, go shopping at the mall. Interviews may be conducted in this fashion. Meetings may be held in a virtual conference between attendees that are hundreds or thousands of miles apart. FIG. 16 illustrates how avatars may be displayed to the user using the virtual city application. Avatar 220 may represent one of the users, while avatar 222 may represent another user. The two users represented by the avatars may interact with one another using chat functions or messaging functions. In one suitable approach, the users may use microphones to transmit their voices to one another. The preceding description is merely an illustrative use of avatars. Any other suitable use may be implemented.

Another feature that may be implemented in the virtual city application is the ability to display local television programming. In particular, television programming for a particular region may be made available to the user currently in the virtual representation of that region. For example, as the user is navigating around his or her virtual hometown, the user may view a local broadcast of a local baseball game.

The virtual city application may also give the user travel-related options—in both the real sense as well as the virtual sense. For example, the user may be given the ability to make airline and hotel reservations. The virtual city application may also have a tour feature, whereby the user may take a virtual tour of a particular destination. For example, if the user wishes to visit New York, the virtual city application may take the user on a guided tour of New York's tourist attractions. The user may be taken to virtual representations of real museums, monuments, neighborhoods, shows, and whatever else the user may wish to see. If desired, a tour guide may accompany the tour via, for example, the avatar feature and the audio capabilities of the present invention, or alternatively via text messages that may accompany the images.

Tours may be based on place, interest, age, or any combination of these or any other suitable factors. For example, the user may wish to see a tour of the jazz scene in New Orleans. The virtual city application may be made to oblige this request and give the user a tour of the jazz clubs, and jazz museums and exhibitions in accordance with the present invention. This is merely an illustrative tour feature. Any such suitable tour feature may be used.

In one embodiment of the present invention, artificial intelligence may be used by the virtual city application to aid users in making full use of the features being offered. In its simplest form, artificial intelligence may take the form of a search engine. As was shown by search box 142 of FIG. 4, users may simply enter keywords and have the virtual city application search for relevant items of interests in the virtual city images or for other types of suitable content.

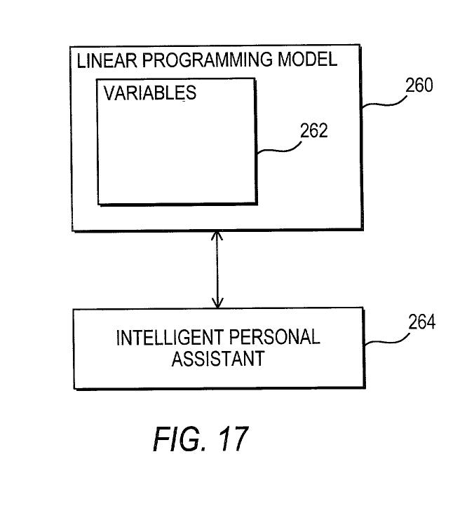

In another suitable approach, a back-end artificial intelligence component of the virtual city application may use a linear programming model to provide users with an intelligent personal assistant. FIG. 17 shows an illustrative linear programming model 260 upon which intelligent personal assistant 264 may be predicated. A large number of variables 262 may be used to make the decision-making of linear programming model 260 more precise. Intelligent personal assistant 264 may be used to, for example, automatically perform personal chores over the Internet. More particularly, the chore management functionality of the present invention may be made programmable and automatable.

By taking into account a user's preferences, habits, dislikes, location, schedule, and any other suitable criteria, the personal assistant feature of the virtual city application may perform many of the user's daily tasks without the need for user interaction. For example, searching for a service provider, such as a dentist may be based on the location criterion of the Upper West Side of Manhattan, the specialization criterion of cosmetic dentistry, and the price criterion of moderately expensive. Any other suitable criteria may be used in having the intelligent personal assistant search for a suitable dentist. In another suitable embodiment, intelligent personal assistant 264 may be given the capability to recommend restaurants based on preferences, pay the user's bills, manage finances, comparison shop for staple items, arrange convenient delivery times (e.g., depending on whether the user lives in a doorman building, when the user is home, etc.) and perform any other suitable services. Any such suitable capability may be given to intelligent personal assistant 264.

In one suitable embodiment of the present invention, the interface of the virtual city application with which the user interacts may be implemented using any suitable hardware, software, or both to create a three-dimensional world. For example, virtual reality markup language (VRML) may be used to create three-dimensional web pages. Any other suitable tools for creating three-dimensional graphics may be used.

Three-dimensional representations of a city may be coupled with the use of a walkthrough interface. For example, as a user navigates around virtual city blocks, the movement appears as a smooth continuous movement. This type of movement is contrasted with the static walkthrough where, as previously described, the user may need to click on horizons or other suitable links to navigate to adjacent locations. Any such suitable type of movement may be used. If desired, the user may be given the option of which movement to use, based on, for example, connection speed, personal likes/dislikes, or based on any other suitable factors.

In one suitable embodiment, the user may be given the ability to use public transportation (or any other suitable form of transportation). For example, the user may take a virtual subway from one location in a virtual city to another location. This may be displayed to the user using a virtual representation of a subway and a virtual representation of a subway car. The user may virtually board the appropriate subway car required to travel to the desired location. This is merely an illustrative use of virtual transportation and the present invention is in no way limited to virtual subways. For example, there may be virtual taxis, virtual buses, virtual horses and carriages (e.g., to take through a virtual Central Park), virtual airplanes (e.g., to go from one virtual city to another), virtual cruises, or any other suitable form of virtual transportation.

Whether using two-dimensional imaging or three-dimensional imaging, the amount of data that is communicated from data server 114 to user hardware 122 (FIG. 2) is potentially huge. In order to make the use of the virtual city application more efficient for those users whose connection speed is relatively slow, some data that is commonly communicated from data server 114 to user hardware 122 may be made available to users on portable media, such as CD-ROM disks, DVD-ROM disk, minidisks, high-capacity floppy disks, or any other suitable type of portable media. The portable media may be sent to the user using, for example, the U.S. Postal Service or any other suitable mail carrier. The content of the portable media may include the most commonly accessed images of a particular region.

In another suitable approach, there may be many different categories of data available on portable media. For example, one such category may relate to art museums. In such a case, the portable media may contain all of the virtual museum images of some of the most popular art museums in the world. The portable media may be required to be used in conjunction with the virtual city application. This is merely an illustrative example of the use of portable media. Any other suitable application for portable media may be used.

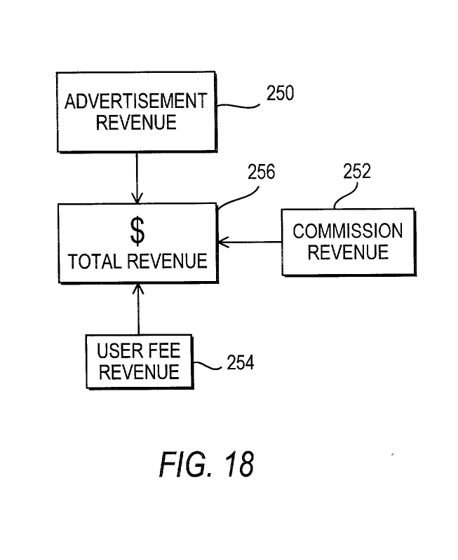

In terms of revenue, the present invention may use any suitable revenue sources. FIG. 18 illustrates some of the possible sources of revenue of the virtual city service. For example, in one suitable approach, total revenue 256 may include advertisement revenue 250. For example, fees may be charged for embedded advertisement based on, for example, the amount of traffic for the particular virtual block on which the advertisement is to appear. In another suitable approach, fees may be based on the type of embedded advertisement that is to be used. For example, billboard advertisements may demand a higher fee than a small sign.

Total revenue 256 may also include commission revenue 252. As was previously described, the virtual city application may process the payments for orders placed by users with merchants that are partnered with the virtual city service. In exchange, the virtual city service may take a fixed fee or a percentage of sale for services rendered in processing the payments.

Total revenue 256 may also include user fee revenue 254. The virtual city service may charge users access fees. Access fees may vary depending, for example, on the level of service desired. For example, a bronze membership may provide users with fewer features than a gold membership. The price for bronze membership may therefore be lower than the price for gold membership. In another suitable approach, users may be charged on a pay-per-view basis. For example, if the user wishes to take a tour of a particular California vineyard, the user may be charged a fee to access that tour. Any such suitable features may be available on a pay-per-view basis.

The preceding is merely illustrative of sources of revenue for the virtual city service. Any other such possible sources of revenue may be used to acquire revenue.

Thus, methods and systems for presenting a virtual representation of a real city are provided. One skilled in the art will appreciate that the present invention can be practiced by other than the described embodiments, which are presented for purposes of illustration and not of limitation, and the present invention is limited only by the claims which follow.

What is claimed is:

1. A method for centralizing localized e-commerce using a virtual city application that provides to users an interface, comprising:
creating virtual representations of stores in the interface in which local merchants are allowed to sell goods and services;
providing the users access to the virtual representations of stores, wherein the users are allowed to place items that are for sale in the virtual representations of stores into a single virtual shopping cart; and
processing payment for the items in the virtual shopping cart using the virtual city application.

2. The method defined in claim 1, further comprising creating virtual representations of stores in the interface in which web-based merchants are allowed to sell goods and services.

3. The method defined in claim 1, wherein creating virtual representations of stores comprises digitizing images of storefronts and images of stores' interiors.

4. The method defined in claim 1, wherein processing payment comprises:
accessing payment information for the users from a database;
receiving funds from the users in payment for the items in the virtual shopping cart based on the payment information; and
placing an order for the items with the respective local merchants.

5. The method defined in claim 4, further comprising:
acquiring revenue by retaining a commission from the funds received; and
paying the respective local merchants the funds received less the commission retained.

6. The method defined in claim 1, wherein providing users access comprises:
allowing the users to access the virtual city application via a communications network;
displaying the virtual city application interface to the users; and
enabling the users to navigate among virtual city block images viewable via the virtual city application interface.

7. The method defined in claim 1, further comprising creating the virtual representations of stores for the respective local merchants.

8. The method defined in claim 1, further comprising acquiring revenue by charging the users a fee for use of the virtual city application.

9. The method defined in claim 1, further comprising acquiring customer information from the users prior to the processing of payment, wherein the acquisition of the customer information occurs only once, and wherein the customer information is used for subsequent purchases made using the virtual city application.

10. The method defined in claim 9 wherein the customer information comprises payment information.

11. A system for centralizing localized e-commerce using a virtual city application that provides to users an interface, comprising:
means for creating virtual representations of stores in the interface in which local merchants are allowed to sell goods and services;
means for providing the users access to the virtual representations of stores, wherein the users are allowed to place items that are for sale in the virtual representations of stores into a single virtual shopping cart; and
means for processing payment for the items in the virtual shopping cart using the virtual city application.

12. The system defined in claim 11, further comprising means for creating virtual representations of stores in the interface in which web-based merchants are allowed to sell goods and services.

13. The system defined in claim 11, wherein means for creating virtual representations of stores comprises means for digitizing images of storefronts and images of stores' interiors.

14. The system defined in claim 11, wherein means for processing payment comprises:
means for accessing payment information for the users from a database;
means for receiving funds from the users in payment for the items in the virtual shopping cart based on the payment information; and
means for placing an order for the items with the respective local merchants.

15. The system defined in claim 14, further comprising:
means for acquiring revenue by retaining a commission from the funds received; and
means for paying the respective local merchants the funds received less the commission retained.

16. The system defined in claim 11, wherein means for providing users access comprises:
means for allowing the users to access the virtual city application via a communications network;
means for displaying the virtual city application interface to the users; and
means for enabling the users to navigate among virtual city block images viewable via the virtual city application interface.

17. The system defined in claim 11, further comprising means for creating the virtual representations of stores for the respective local merchants.

18. The system defined in claim 11, further comprising means for acquiring revenue by charging the users a fee for use of the virtual city application.

19. The system defined in claim 11, further comprising means for acquiring customer information from the users prior to the processing of payment, wherein the acquisition of the customer information occurs only once, and wherein the customer information is used for subsequent purchases made using the virtual city application.

20. The system defined in claim 9 wherein the customer information comprises payment information.

21. A system for centralizing localized e-commerce using a virtual city application that provides to users an interface, comprising:
a central site at which virtual representations of stores are created for use in the interface in which local merchants are allowed to sell goods and services;
a data server configured to provide the users access to the virtual representations of stores, wherein the users are allowed to place items that are for sale in the virtual representations of stores into a single virtual shopping cart; and
hardware at the central site configured to process payment for the items in the virtual shopping cart using the virtual city application.

22. The system defined in claim 21, further comprising hardware at the central site configured to create virtual representations of stores in the interface in which web-based merchants are allowed to sell goods and services.

23. The system defined in claim 21, further comprising hardware at the central site configured to digitize images of storefronts and images of stores' interiors.

24. The system defined in claim 21, further comprising:
an information database that stores payment information for the users;
a communications network that is used to transfer funds for payment for the items in the virtual shopping cart using the payment information; and
hardware at the central site configured to place an order for the items with the respective local merchants.

25. The system defined in claim 21, further comprising:
a communications network configured to allow the users to access the virtual city application;
graphics processing and display hardware configured to display the virtual city application interface to the users; and
user control hardware configured to enable the users to navigate among virtual city block images viewable via the virtual city application interface.

26. The system defined in claim 21, further comprising hardware at the central site configured to create the virtual representations of stores for the respective local merchants.

27. The system defined in claim 21, further comprising hardware at the central site configured to acquire customer information from the users prior to the processing of payment, wherein the acquisition of the customer information occurs only once, and wherein the customer information is used for subsequent purchases made using the virtual city application.

28. The system defined in claim 27, wherein the customer information comprises payment information.

29. A method for providing a user an interactive virtual representation of a city via a communications network, comprising:
storing images of substantially most city blocks making up the city in a database;
linking the images to one another in substantially the same way the corresponding city blocks are linked; and
allowing the user to navigate among the city blocks.

30. The method defined in claim 29, further comprising inserting embedded advertisements within the images.

31. The method defined in claim 29, further comprising:
allowing the user to select areas of the images; and
performing an action upon the user selecting one of the areas.

32. The method defined in claim 31, wherein performing an action comprises displaying additional information.

33. The method defined in claim 29, further comprising:
displaying storefronts in the images;
allowing the user to select at least one of the storefronts; and
displaying a virtual representation of the inside of a store corresponding to a selected storefront.

34. The method defined in claim 29, wherein allowing the user to navigate comprises:
allowing the user to select a particular direction of a first city block; and
displaying a second city block that is linked to the first city block.

35. The method defined in claim 29, further comprising:
displaying an image of a map having selectable areas;
allowing the user to select the selectable areas; and
displaying a city block that corresponds to an area selected from the map.

36. A system for providing a user an interactive virtual representation of a city via a communications network, comprising:
a database in which images of substantially most city blocks making up the city are stored;
hardware configured to link the images to one another in substantially the same way the corresponding city blocks are linked; and
hardware configured to allow the user to navigate among the city blocks.

37. The system defined in claim 36, further comprising graphics editing equipment that is used to insert embedded advertisements within the images.

38. The system defined in claim 36, further comprising hardware configured to:
allow the user to select areas of the images; and
perform an action upon the user selecting one of the areas.

39. The system defined in claim 38, wherein the hardware is further configured to display additional information.

40. The system defined in claim 36, further comprising hardware configured to:
display storefronts in the images;
allow the user to select at least one of the storefronts; and
display a virtual representation of the inside of a store corresponding to a selected storefront.

41. The system defined in claim 36, further comprising hardware configured to:
allow the user to select a particular direction of a first city block; and
display a second city block that is linked to the first city block.

42. The system defined in claim 36, further comprising hardware configured to:
display an image of a map having selectable areas;
allow the user to select the selectable areas; and
display a city block that corresponds to an area selected from the map.

43. A method for using a linear programming model to provide automated services based on a plurality of variables, comprising:
using the linear programming model to process a user's preferences, schedule, and requests; and
performing actions based on the linear programming model over a communications network.

44. The method defined in claim 43, wherein the performing actions is selected from a group consisting of making appointments, placing orders for items, placing orders for services, scheduling deliveries, and any combination thereof.
